(19) United States
(12) Patent Application Publication
(10) Pub. No.: US 2012/0075153 A1
(43) Pub. Date: Mar. 29, 2012

(54) WIDEBAND AND MULTIBAND EXTERNAL ANTENNA FOR PORTABLE TRANSMITTERS

(75) Inventor: Parameswaran A. Sivalingam, Perak (MA)

(73) Assignee: Motorola, Inc., Schaumburg, IL (US)

(21) Appl. No.: 12/890,820

(22) Filed: Sep. 27, 2010

(51) Int. Cl. H01Q 1/50

(52) U.S. Cl. 343/749

(57) ABSTRACT

A communication device is presented that has a multiband antenna structure. A helical load extends from a monopole and reduces the resonance frequency of the monopole to the UHF band while leaving a GPS resonance of the monopole substantially unchanged. Helical proximate and distal portions are connected to the load such that the overall antenna structure has a VHF resonance. The helical portions have different characteristics and are configured to not substantially affect the UHF or GPS resonances. The helical portions have different pitch angles to permit minimization of the length of the combined helical portions while providing a desired operating VHF bandwidth.

### TECHNICAL FIELD

The present application relates generally to a communication device and in particular to a communication device containing a multi/broadband antenna.

### BACKGROUND

With the continued and ever-increasing demand for portable communication devices coupled with the advance of various technologies, it has been desirable to provide the ability of portable communication devices to communication in different frequency bands. The ability to use multiple frequency bands has many advantages, for example, permitting communications in different locations around the world in which one or more of the different bands are used, providing a backup so that the same information can be provided through the different bands, or permitting different information to be provided to the device using the different frequencies and permitting the device to determine the manner in which to respond to the different information.

Although a system of separate antennas may be employed in which the individual antennas are electronically and/or mechanically switched in and out of operation as desired, such a system has multiple problems: it is expensive, requires complex algorithms to effectuate the switching, consumes a substantial amount of power to switch from one antenna to another, can generally only handle low power transmissions, and introduces a significant amount of distortion causing out of band energy spreading over many spurious frequencies. It is thus desirable to limit the number of separate antennas to a single combined passive structure that functions in the multiple bands. One particularly useful combination of bands includes RF bands (very high frequency (VHF) band (about 136-174 MHz) and ultra high frequency (UHF) band (about 380-520 MHz)) and the Global Positioning Satellite (GPS) band (1.575 GHz). This combination is particularly desirable for public safety providers (e.g., police, fire department, emergency medical responders, and military) who have traditionally used the VHF/UHF bands maintained exclusively for public safety purposes. With the advent of GPS, it has become desirable to be able to determine locations of the public safety providers to better manage increasingly scarce resources, coordinate quicker response, and guide personnel safely through potentially dangerous situations.

It is especially challenging however to combine individual antennas with these operating bandwidths into a single compact structure, especially as antenna radiation patterns in the RF bands resemble vertical dipoles while those in the GPS band are maximized in the vertical direction (to communicate with the GPS satellites). Although it is desirable to provide a single antenna structure covering the above set of frequency ranges, present antenna structures are unable to provide sufficient operation range, compact design and efficient radiation patterns. It is thus desirable to provide a combined antenna structure that has sufficient performance while retaining a relatively simple structure to address various mechanical design objectives.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates one embodiment of a communication device.

FIG. 2 illustrates an internal block diagram of an embodiment of a communication device.

FIG. 3 shows an embodiment of an antenna structure.

FIG. 4 shows a flowchart of an embodiment of designing an antenna structure.

FIG. 5 shows a simulation of the frequency response of an embodiment of an antenna structure.

FIG. 6 shows a simulation of the UHF frequency response of an embodiment of an antenna structure compared to a prior art UHF antenna structure.

FIG. 7 shows a simulation of the effects on the frequency response when adjusting the number of turns in an embodiment of an antenna structure.

FIG. 8 shows a simulation plot of the current flow in an embodiment of an antenna structure.

FIGS. 9A-9E shows simulation of the radiation patterns of an embodiment of an antenna structure vs. a previous design.

FIG. 10 shows a simulation plot of the GPS current flow in an embodiment of an antenna structure vs. a previous design.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments of shown.

The apparatus and method components have been represented where appropriate by conventional symbols in the drawings, showing only those specific details that are pertinent to understanding the embodiments shown so as not to obscure the disclosure with details that will be readily apparent to those of ordinary skill in the art having the benefit of the description herein. Other elements, such as those known to one of skill in the art, may thus be present.

### DETAILED DESCRIPTION

Before describing in detail the various embodiments, it should be observed that such embodiments reside primarily in combinations of apparatus components related to a multiband antenna structure having different sections. A helical load extends from a monopole and reduces the resonance frequency of the monopole to the UHF band while leaving a GPS resonance of the monopole substantially unchanged. Helical proximate and distal portions are connected to the load such that the overall antenna structure has a VHF resonance. The helical portions have different characteristics and are configured to not substantially affect the UHF or GPS resonances. The helical portions have different pitch angles to permit minimization of the length of the combined helical portions while providing a desired operating VHF bandwidth.

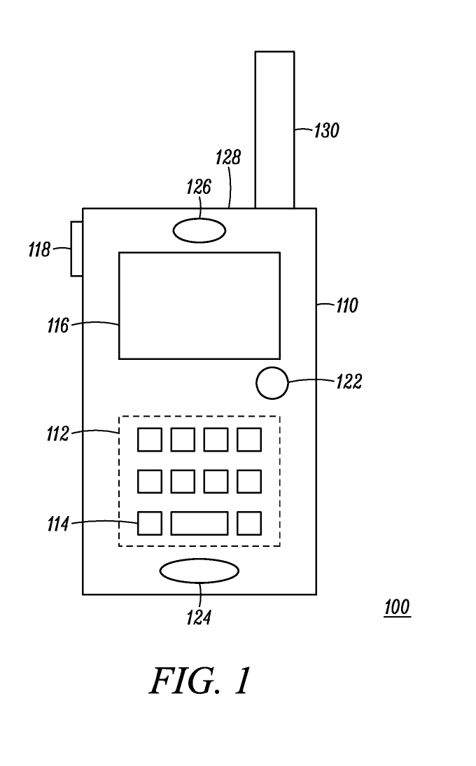

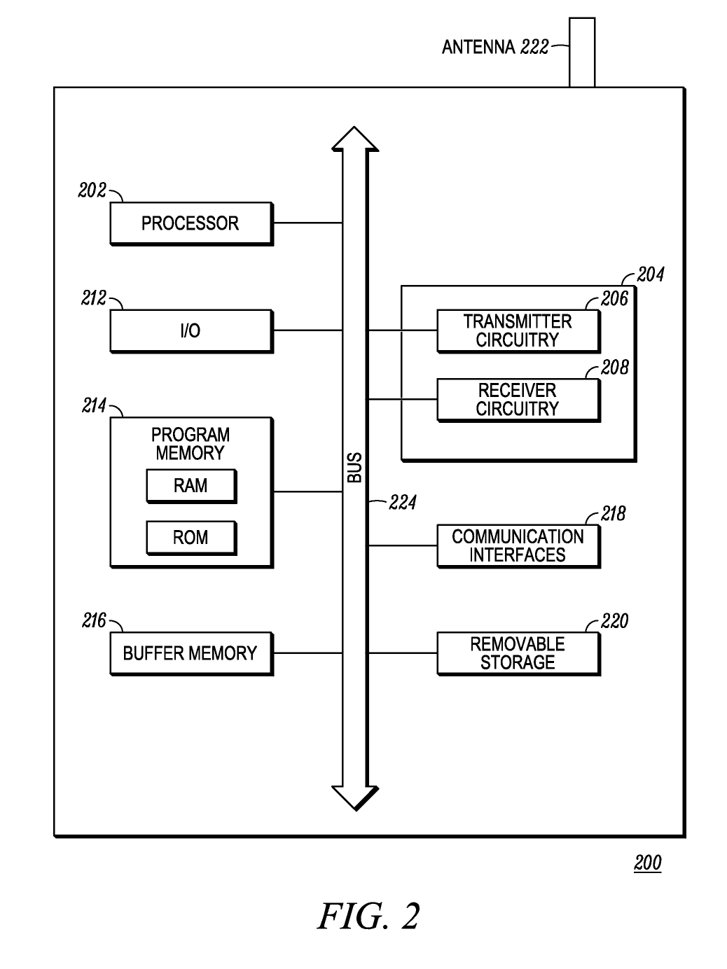

One embodiment of a portable communication device is shown in FIG. 1. The communication device 100 has a body 110 to which the antenna structure 130 is connected via known means such as screwing in the antenna structure 130 to a tapped receiving structure (not shown) in the body 110. The tapped receiving structure typically resides in the top face 128 of the radio. The antenna structure 130 provides multiband transmission and reception. The body 110 contains internal communication components and circuitry as further described with relation to FIG. 2 to enable the device 100 to communicate wirelessly with other devices using the antenna structure 130. The body 110 also contains I/O devices such as a keyboard 112 with alpha-numeric keys 114, a display 116 (e.g., LED, OELD) that displays information about the device 100, a PTT button to transmit 118, a channel selector knob 122 to select a particular frequency for transmission/reception, soft and/or hard keys, touch screen, jog wheel, a microphone 124, and a speaker 126. The channel selector knob 122 and/or keyboard 112, for example, may be used to select the operating band/channel of the antenna structure 130. Not all of the I/O devices shown in FIG. 1 may, of course, be present depending on the particular communication device 100 in which the antenna structure 130 is being employed.

Turning to the electronics within the communication device, one embodiment is shown in the block diagram of FIG. 2. The communication device 200 contains, among other components, a processor 202, a transceiver 204 including transmitter circuitry 206 and receiver circuitry 208, an antenna 222, the I/O devices 212 described in relation to FIG. 1, a program memory 214 for storing operating instructions (such as estimation and correction of a received signal and encryption/decryption) that are executed by the processor 202, a buffer memory 216, one or more communication interfaces 218, and a removable storage 220. The communication device 200 is preferably an integrated unit containing at least all the elements depicted in FIG. 2, as well as any other element necessary for the communication device 200 to perform its electronic functions. The electronic elements are connected by a bus 224.

The processor 202 includes one or more microprocessors, microcontrollers, DSPs, state machines, logic circuitry, or any other device or devices that process information based on operational or programming instructions. Such operational or programming instructions are preferably stored in the program memory 214. The program memory 214 may be an IC memory chip containing any form of random access memory (RAM) or read only memory (ROM), a floppy disk, a compact disk (CD) ROM, a hard disk drive, a digital video disk (DVD), a flash memory card or any other medium for storing digital information. One of ordinary skill in the art will recognize that when the processor 202 has one or more of its functions performed by a state machine or logic circuitry, the program memory 214 containing the corresponding operational instructions may be embedded within the state machine or logic circuitry. The operations performed by the processor 202 and the rest of the communication device 200 are described in detail below.

The transmitter circuitry 206 and the receiver circuitry 208 enable the communication device 200 to respectively transmit and receive communication signals. In this regard, the transmitter circuitry 206 and the receiver circuitry 208 include appropriate circuitry to enable wireless transmissions. The implementations of the transmitter circuitry 206 and the receiver circuitry 208 depend on the implementation of the communication device 200 and the devices with which it is to communicate. For example, the transmitter and receiver circuitry 206, 208 may be implemented as part of the communication device hardware and software architecture in accordance with known techniques. One of ordinary skill in the art will recognize that most, if not all, of the functions of the transmitter or receiver circuitry 206, 208 may be implemented in a processor, such as the processor 202. However, the processor 202, the transmitter circuitry 206, and the receiver circuitry 208 have been artificially partitioned herein to facilitate a better understanding. The buffer memory 216 may be any form of volatile memory, such as RAM, and is used for temporarily storing received information.

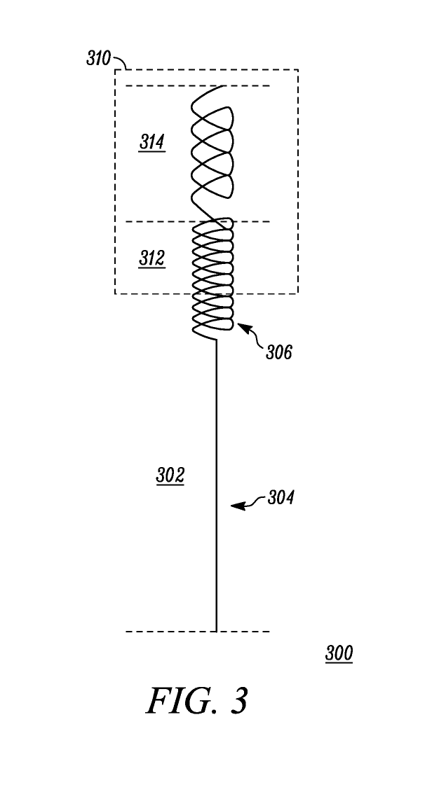

One embodiment of various layers of an entirely passive antenna structure is shown in FIG. 3. As illustrated, the antenna structure 300 is formed from two sections: a base section 302 (first radiating element) and a terminal section 310 (second radiating element) galvanically connected with the base section 302. The base section 302 is formed from a monopole 304 (also called whip) and a helical extension 306 extending from the end of the monopole 304 more distal to the body of the communication device to which the antenna 300 is connected than the monopole 304. As shown in FIG. 3, the helical extension 306 extends from the monopole 304 (is galvanically connected with), which is relatively mechanically stable. In other embodiments, however, the monopole may extend from a helical extension that is connected with the body of the communication device. The antenna 300, when used for transmission, is supplied with signals at the terminus of the base portion 302.

The terminal section 310 is formed from a proximate portion 312 and a distal portion 314 galvanically connected with the proximate portion 312. As shown, the proximate portion 312 is more proximate to (and in fact is directly connected to) the helical extension 306 of the base section 310 than the distal portion 314, which terminates the antenna 300. The proximate portion 312 and distal portion 314 are formed from helixes and are defined by the diameter of the coils, the number of coils, and the pitch angle of the coils (space between adjacent coils).

In the embodiment shown in FIG. 3, the proximate portion 312 and distal portion 314 have the same coil diameter (about 4 mm-7 mm), but different coil numbers. The diameter of the coils in the helix of the helical extension 306 is the same as the diameter of the coils in the proximate portion 312 and distal portion 314. Although each of these three diameters may be independent of each other, it is desirable from a mechanical and esthetical sense to have an antenna of relatively uniform thickness or that tapers with increasing distance from the body of the communication device (perhaps with a terminus that is somewhat larger). Thus, it is desirable to maintain or decrease the coil diameter with this increasing distance. The centers of the helixes of the proximate portion 312 and distal portion 314 are aligned with the center of the helix of the helical extension 306 and the monopole 302.

The proximate portion 312 and distal portion 314 also have different pitch angles. A pitch angle of the distal portion 314 is between two to four times that of the proximate portion 312. In one embodiment, the pitch angle of the proximate portion 312 is about 1-5 mm while the pitch angle of the distal portion 314 is about 2-9 mm. The pitch angle of the proximate portion 312 may be the same as that of the helical extension 306.

The numbers of turns are different in each of the proximate portion 312 and distal portion 314. For example, the number of turns in the proximate portion 312 is up to about seven times the number of turns in the helical extension 306. There are significantly fewer turns in the distal portion 314 than in the proximate portion 312. For example, the distal portion 314 may have up to about ⅕ the number of turns in the proximate portion 312. As above, the relative positions of the proximate portion 312 and distal portion 314 can be exchanged in other embodiments.

Turning to the electrical aspects of the antenna 300, the length of the monopole 304 is a whip antenna having a quarter-wave (λ/4) resonance at 525 MHz. This also produces an additional third-order harmonic resonance at the GPS frequency (1575 MHz). However, because the UHF band is somewhat lower (380-520 MHz) than the resonance of the monopole 304, the helical extension 306 is connected to the end of the monopole 304. The addition of the helical extension 306 provides additional inductive load that reduces the resonance of the base section 302 to be within the UHF band. The UHF resonance is designed using the three properties (pitch angle, diameter and turns). The helical extension 306 is also designed to have a half-wave resonance at the GPS frequency so that it does not significantly affect the GPS resonance of the monopole 304 (including the radiation pattern of the monopole 304). The resulting structure of the base section 302 is a 5λ/4 (i.e. λ/4) GPS element and a λ/4 UHF element having a single feed point.

Although the base section 302 provides resonances at UHF and GPS frequencies, an additional structure is employed to provide a quarter-wave VHF resonance for the overall antenna 300. The VHF resonance is provided by the addition of the terminal section 310 to the base portion 302. Specifically, the terminal section 310 adds a half-wave UHF element to the quarter-wave UHF element formed by the base section 302, thereby forming a 3λ/4 UHF section. This does not significantly affect the GPS response (either the position of the resonance or the radiation pattern) of the base portion 302 as the 3λ/4 (i.e. λ/4) UHF section is about 9λ/4 (i.e. λ/4) at the GPS frequency.

In addition to preserving the desired resonances, the radiation pattern at the UHF and GPS is also preserved when adding the terminal section 310. To achieve this, the UHF and GPS antenna currents at the terminal section 310 should be minimized, as should the axial length of the terminal section 310. However, minimizing the terminal section 310 leads to a helix design that uses smaller pitch angles, thereby reducing the operating bandwidth at the VHF band by increasing the capacitance. To satisfy these conflicting demands, a dual-pitch angle design is employed in which one segment (the proximate portion 312) is of a smaller pitch angle than the other segment (the distal portion 314). To this end, the lengths of the base section 302 and terminal section 310 are substantially different; specifically, the length of the terminal section 310 is substantially smaller than the length of the base section 302. In one embodiment, the length of the terminal section 310 is about ¾ that of the base section 302.

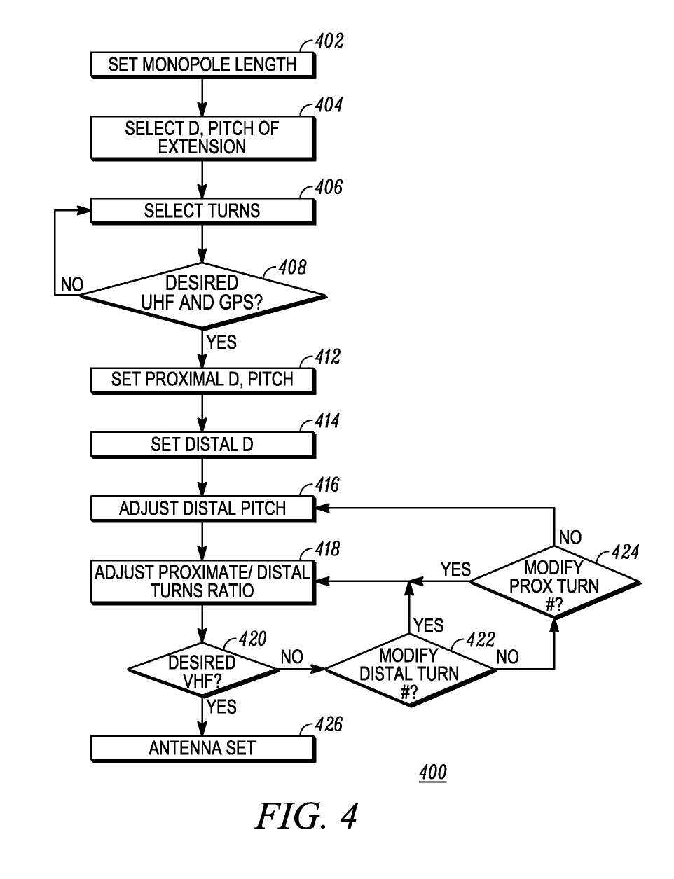

In FIG. 3 while it appears that the helical extension 306 of the base section 302 and the proximate portion 312 are the same coil, these elements have the same properties essentially for manufacturing ease. In actuality, they are designed entirely separately and thus the various properties (diameter, turns, pitch angle) are entirely independent of each other). This is further described below with reference to the flowchart of FIG. 4.

One method of designing the desired antenna structure is shown in FIG. 4. The monopole length is set at step 402 to provide the desired UHF and GPS resonance and radiation pattern. The length should be selected such that the secondary resonance of the monopole falls right at the GPS frequency. Next, at step 404 the diameter and pitch angle of the extension portion are established and in step 406, the number of turns of the extension portion are set. It is then determined at step 408 whether the resonance is obtained at the UHF and GPS frequencies i.e. the extension portion should be a λ/2 element at GPS. This is performed with the use of simulation tools that show the profile of antenna current across the extension portion, which provides a visualization of the electrical length. If not, the process returns to step 406, in which the number of turns is adjusted in the appropriate manner to either increase the frequency if the extension portion is too long or decrease the frequency if the extension portion is too short.

Once the characteristics of the base section are designed, the terminal section is designed. First, at step 412, the diameter and coil pitch angle of the proximate portion are set to match that of the base section. The diameter of the coils in the distal portion is then set to that of the proximate portion at step 414. At step 416, a pitch angle of the distal portion is selected. This pitch angle is relative to the pitch angle of the proximate portion and in one embodiment is about 2-5 times that of the proximate portion. The antenna structure is designed so that the relative length of the base section is at least that of the terminal section to ensure that the radiation pattern of the entire structure is not dominated by the terminal section.

At step 418, the number of turns in each of the proximate and distal portions is selected. Initially, the number of turns in the proximate and distal portions may be set to be equal or at some other ratio depending on known initial conditions. For example, to minimize the overall combined axial length of the proximate and distal portions, the number of coils in the proximate portion is maximized while the number of coils in the distal portion is minimized (as the pitch angle of the coils in the distal portion is much larger than that in the proximate portion). The antenna structure is then simulated or otherwise tested at step 420 to determine whether the desired frequency resonance and operating bandwidth (e.g., 12-13 MHz) in the VHF band is met. If the characteristics (antenna length, operating bandwidths, resonances, radiation pattern) are acceptable, at step 424, the process terminates and the design is acceptable.

If the characteristics are not acceptable, at step 422 it is determined whether the number of turns of the distal portion can be further adjusted to provide the desired characteristics. If further modification of the distal portion is acceptable, the process returns to step 418, where the number of turns in the distal portion is adjusted. If further modification of the distal portion is not acceptable, at step 424 it is determined whether the number of turns of the proximate portion can be further adjusted to provide the desired characteristics and, if so, the process returns to step 418, where the number of turns in the proximate portion is adjusted. If further modification of the number of turns in the proximate portion is not acceptable, the process returns to step 416 where the pitch angle of the distal portion is modified. Although not shown, if modification of the turns of the distal portion and proximate portion nor of the pitch angle of the distal portion is sufficient, the process may then turn to adjusting the pitch angle of the proximate portion.

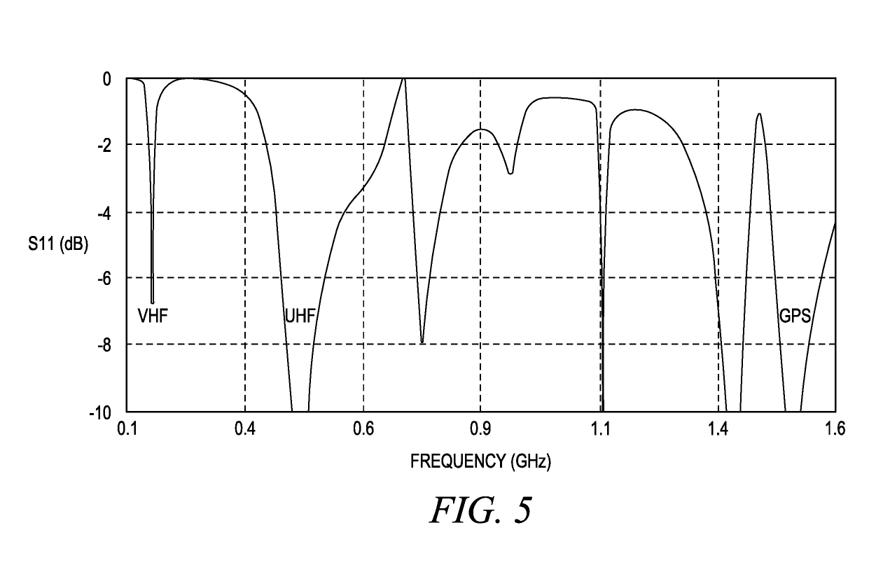

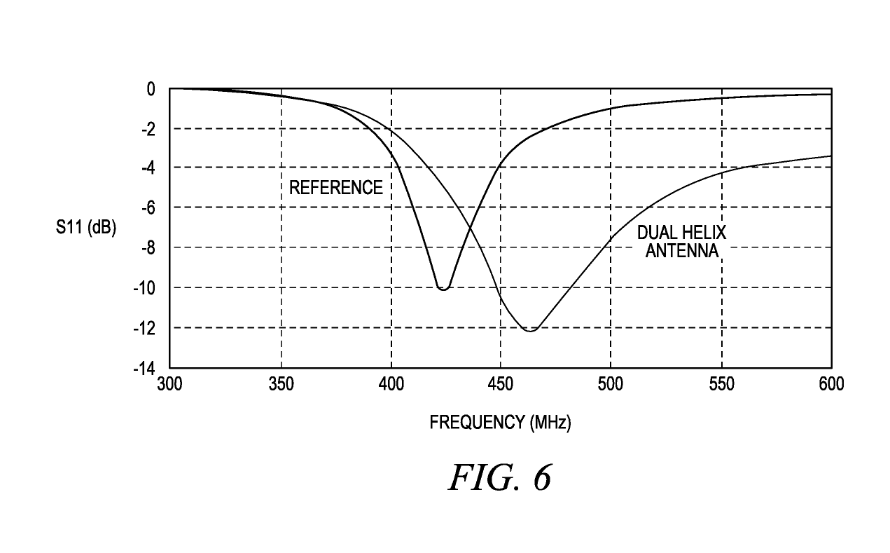

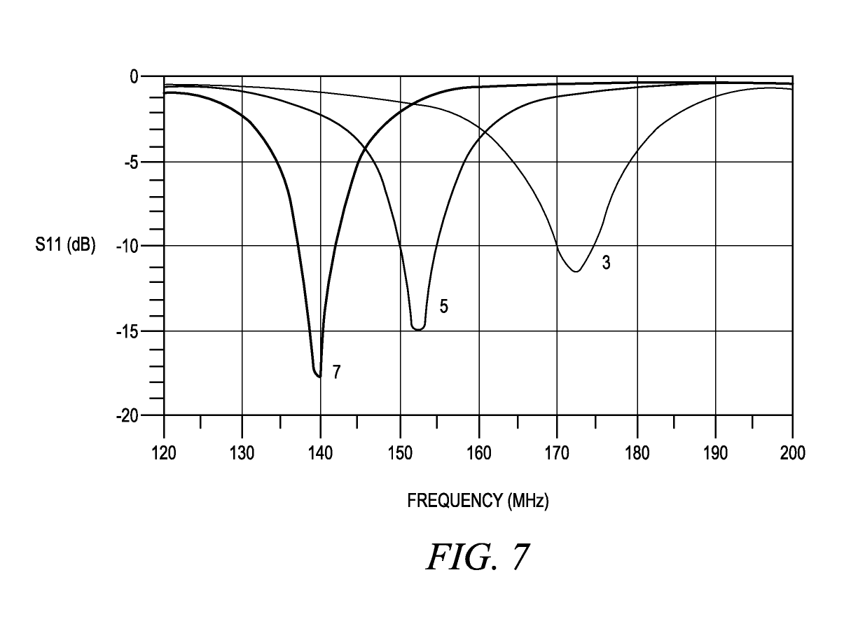

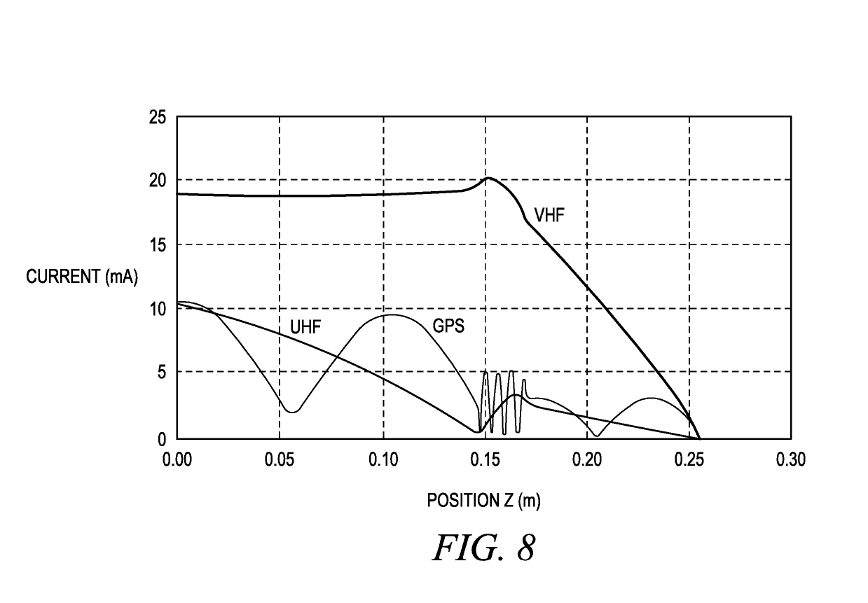

Simulated results of the entire bandwidth range and antenna currents are shown in FIGS. 5-8. As seen in FIG. 5, the width of the VHF band resonance is relatively narrow and, compared to prior antennae, as shown in FIG. 6 the width of the UHF operating bandwidth is increased by a factor of about three. The existing antenna has three helical segments all having 6 mm diameter: the base section having 3 turns of 5 mm pitch, the middle section having 5 turns of 1 mm pitch, and the top section having 6 turns of 5 mm pitch; the new antenna has a whip length of 142 mm and diameter of 1 mm, a helical load having 5 turns of 1 mm pitch, a proximate portion having 25 turns of 7 mm pitch, and a distal portion having 11 turns of 7 mm pitch in which each helical element has a 6 mm diameter. As shown in FIG. 7, the VHF response decreases in frequency as the number of turns of the distal portion increases. Specifically, the VHF resonance using 7 turns is 136-146 MHz, using 5 turns is 146-158 MHz, and using 3 turns is 164-179 MHz. Although not shown, the UHF resonance shifts slightly when the number of turns of the distal portion is adjusted, although the GPS resonance is not affected substantially. FIG. 8 illustrates current flow in the different bands for the antenna design shown in FIG. 5. The distance shown is measured from the feed point of the antenna. The overall length of the antenna is about 25 cm, with the base section being about 15 cm and the terminal section being about 10 cm. As desired, the VHF current is substantially constant throughout the base section, tapering off relatively linearly in the terminal section; the UHF band indicates a node near the junction between the base and terminal sections (the terminal section acts like a choke), and the GPS band shows a 3λ/4 pattern in the base section, with 2λ in the terminal section.

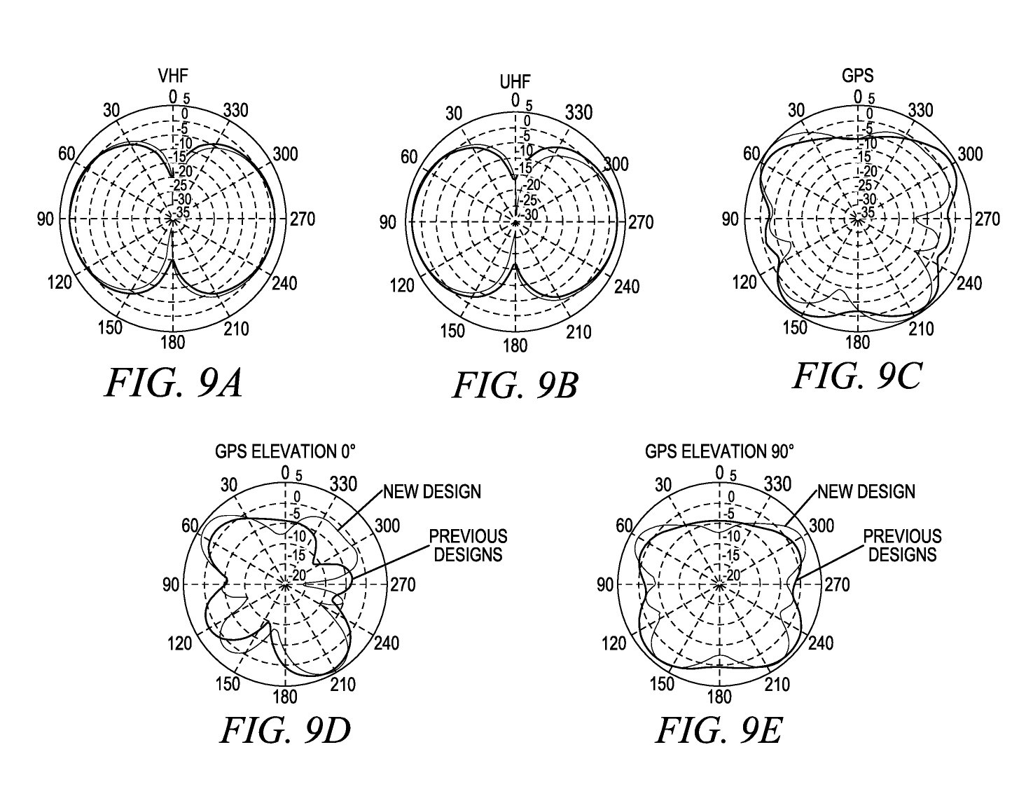

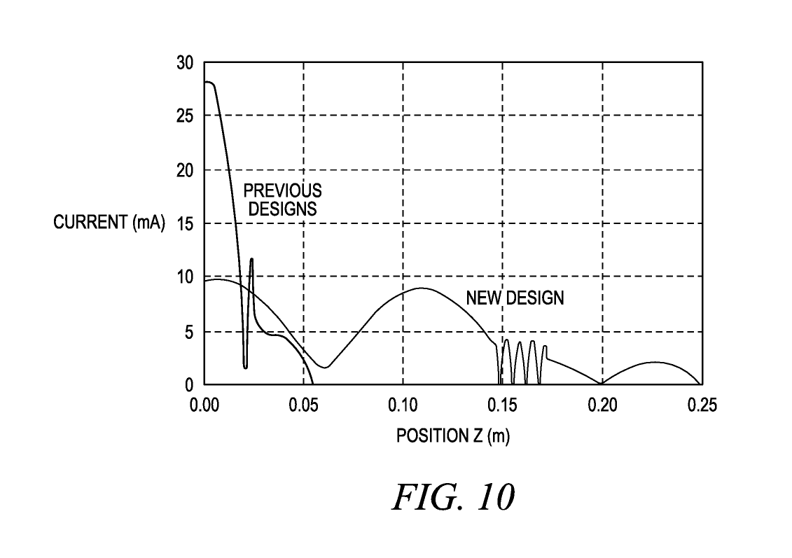

FIGS. 9A-9C show VHF, UHF and GPS simulated radiation patterns for the design shown in FIGS. 5-8. The VHF and UHF elevation (side) radiation patterns (FIGS. 9A and 9B) and GPS open-sky (top) radiation pattern (FIG. 9C) show good results. A comparison between the GPS top radiation pattern of a previous antenna design with the new antenna design is shown in FIGS. 9D and 9E, which indicates an increase in GPS radiation efficiency towards the upper elevation angles. This is commonly computed as the open-sky efficiency which is a ratio of power radiated in the upper half elevation angles over the total radiated power. Simulated improvement of open-sky efficiency of about 19% was achieved from about 30.5% to about 49.5%. As clearly shown, the radiation patterns are more focused towards the vertical and hence improve the performance with regards to the position of the GPS satellites. FIG. 10 shows the simulated antenna current of the new design in comparison with the previous design. The effective electrical wavelength of the GPS current (3λ/4) is essentially similar between the two designs, although the realized physical length is substantially longer on the new design (by about 2.5 times). This provides for improved GPS radiation efficiency for a given antenna counterpoise length.

In another embodiment, a lumped element matching circuit may be added between the base portion and the body of the communication device. This results in the creation of a wide-band VHF resonance. For example, simulated results indicate that when a lumped element matching circuit is added to an antenna having a resonance at about 158 MHz and an azimuthal gain whose −3 dB range is about 150 MHz-165 MHz and −6 dB range is 145 MHz-172 MHz, the azimuthal gain is relatively constant over the same frequency ranges. The matching network uses a high-pass topology, which further simulations show do not impact the UHF or GPS resonance.

As shown, the helical coils in the extension portion and the proximate and distal portions of the terminal section have a uniform diameter and pitch along their respective lengths. In other embodiments, the pitch and/or diameter may vary relatively slowly (e.g. by ½ or less) over the length of the coil. Additionally, a predetermined number of segments with different pitch angles may be employed as the proximate and distal portions of the terminal section. The segments can be of any fraction of the UHF frequency so long as the combined net electrical length of the proximate and distal portions is a half-wave at UHF.

In another embodiment one or more transition regions may be present between the extension portion and the terminal section and/or between the proximate and distal portions of the terminal section. The transition regions may be formed from a relatively short (compared with any of the portions, e.g., less than about ¼ of the length of an adjacent portion) helical coil whose pitch and/or diameter changes from one end to the other. This transition region may also be a short helical coil of constant pitch and/or diameter between that of the portions it galvanically joins.

The use of the term “about” is relatively widespread herein. About as used is not more than 10% of the value being modified, and in most instances is no more than 5% or no more than 1-2% of the modified value. If a particular result is to be obtained, e.g., resulting antenna characteristic such as resonance at a particular frequency or efficiency of a particular mode, the term “about” may be limited in some instances by a difference from that particular result (e.g., within 10%, 5% or 1-2%) rather than the modified value.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure and Summary section are provided to allow the reader to quickly ascertain the nature of the technical disclosure. It is submitted with the understanding that neither will be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Those skilled in the art will recognize that a wide variety of modifications, alterations, and combinations can be made with respect to the above described embodiments without departing from the spirit and scope of the invention and that such modifications, alterations, and combinations are to be viewed as being within the scope of the inventive concept. Thus, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims issuing from this application. The invention is defined solely by any claims issuing from this application and all equivalents of those issued claims.

1. A multiband antenna structure comprising:
a first radiating element containing a base and a load extending from the base, the base having a primary resonance and a secondary resonance that is an nth-order harmonic of the primary resonance, the load reducing the primary resonance, without substantially affecting the secondary resonance, such that the first radiating element has a first resonance and the secondary resonance; and
a second radiating element galvanically coupled with the first radiating element such that the antenna structure also has a third resonance distinct from the first and secondary resonances, the second radiating element configured to not substantially affect the first or secondary resonance and having proximate and distal portions of different characteristics.

2. The antenna structure of claim 1, wherein the base is a monopole and the load is a helical extension having a pitch angle, a diameter, and a number of turns.

3. The antenna structure of claim 1, wherein the proximate and distal portions are helixes having at least one of different pitch angles, different diameters, or different numbers of turns.

4. The antenna structure of claim 3, wherein the proximate and distal portions are helixes having at least one of different pitch angles, different diameters, or different numbers of turns.

5. The antenna structure of claim 4, wherein the proximate and distal portions have different pitch angles and different numbers of turns but the same diameter.

6. The antenna structure of claim 5, wherein the base is a monopole and the load is a helical extension having a pitch angle, a diameter, and a number of turns that are independent of the pitch angles, diameters and number of turns of the proximate and distal portions.

7. The antenna structure of claim 6, wherein the helical extension has the same diameter as the proximate and distal portions, the same pitch angle as the proximate portion, and a different numbers of turns than either the proximate or distal portion.

8. The antenna structure of claim 7, wherein the helical extension is directly connected to the proximate portion.

9. The antenna structure of claim 4, wherein the pitch angle of the distal portion is about two to five times that of the proximate portion.

10. The antenna structure of claim 4, wherein the number of turns of the proximate portion is at least about twice that of the distal portion.

11. The antenna structure of claim 1, wherein the first radiating element is at least about as long as the second radiating element.

12. The antenna structure of claim 1, wherein the first resonance is in a UHF frequency band, the secondary resonance is a GPS frequency and the third resonance is in a VHF frequency band.

13. The antenna structure of claim 12, wherein the first radiating element is a 5λ/4 GPS element and a λ/4 UHF element, the load is a λ/2 GPS element, the combination of the proximate and distal portions form a λ/2 UHF element and about a 3λ/2 GPS element, and the combination of the first and second radiating elements is a λ/4 VHF element, 3λ/4 UHF element and 13λ/4 GPS element.

14. The antenna structure of claim 12, wherein a radiation pattern at the UHF frequency band and GPS frequency is substantially the same with the first radiating element as without the second radiating element.

15. A triband antenna structure comprising:
a first radiating element containing a base and a load extending from the base, the base having a UHF resonance and a GPS resonance, the load reducing a resonance of the base and providing a λ/2 GPS element; and
a second radiating element galvanically connected to the load and having helical proximate and distal portions such that the second radiating element forms a 3λ/2 GPS element and a λ/2 UHF element, the combination of the first and second radiating elements having a VHF resonance, the proximate and distal portions having different pitch angles.

16. The antenna structure of claim 15 wherein the base is a monopole and the load is a helical extension having a pitch angle, a diameter, and a number of turns that is connected to the proximate portion.

17. The antenna structure of claim 16, wherein the helical extension has a pitch angle, a diameter, and a number of turns that are independent of the pitch angles, diameters and number of turns of the proximate and distal portions.

18. The antenna structure of claim 17, wherein the helical extension has the same diameter as the proximate and distal portions, the same pitch angle as the proximate portion, and a different numbers of turns than either the proximate or distal portion.

19. The antenna structure of claim 18, wherein the pitch angle of the distal portion is about two to four times that of the proximate portion.

20. The antenna structure of claim 19, wherein the number of turns of the proximate portion is at least about twice that of the distal portion.
